(19) United States
(12) Patent Application Publication
(10) Pub. No.: US 2015/0344679 A1
(43) Pub. Date: Dec. 3, 2015

(54) Appearance Enhancer For Rubber Compositions With Antidegradants

(71) Applicant: BRIDGESTONE AMERICAS TIRE OPERATIONS, LLC, Nashville, TN (US)

(72) Inventor: Craig R. Balnis, Akron, OH (US)

(73) Assignee: BRIDGESTONE AMERICAS TIRE OPERATIONS, LLC, Nashville, TN (US)

(21) Appl. No.: 14/654,083

(22) PCT Filed: Dec. 16, 2013
(86) PCT No.: PCT/US2013/075428

§ 371 Date: Jun. 19, 2015

Related U.S. Application Data
(60) Provisional application No. 61/745,831, filed on Dec. 26, 2012.

(51) Int. Cl. C08L 9/00; B60C 1/00

(52) U.S. Cl. CPC C08L 9/00; B60C 1/0025; C08L 2201/08; C08L 2312/00; C08L 2205/03

(57) ABSTRACT

The addition of a polyester resin comprising a copolymer of maleic anhydride or maleic acid and a linear or branched polyol, to a rubber composition provides a black, glossy appearance on the outer, exposed surface. The rubber composition may be formed into a tire sidewall component of a tire.

### FIELD

This disclosure relates to rubber compositions and pneumatic tires using the same, and more particularly to a rubber composition for a tire sidewall exposed to atmospheric conditions.

### BACKGROUND

Due to the nature of the elastomers used in rubber compounding, antidegradants are typically included in a rubber formulation to prevent atmospheric attack of the rubber compound. Elastomers having unsaturation in the polymer backbone are particularly vulnerable to ozone attack, which causes cracking on the surface of the rubber.

In order to inhibit reaction between atmospheric ozone and the polymer backbone, materials that are considered “antidegradants” are commonly used. These may include materials which bloom to the surface of the rubber, preventing reaction of atmospheric ozone with the polymer. For example, certain waxes are known to migrate to the rubber surface, forming an inert film that provides a layer of protection to the rubber from atmospheric ozone. Other known antidegradants include chemicals that inhibit crack formation or minimize the rate of crack growth.

A drawback to these types of antidegradants is their effect on the appearance of the rubber surface. A black, glossy rubber surface is aesthetically desirable, particularly on a tire sidewall, which is one of the most visible components of a tire. Wax films may cause the surface to appear dull, or hazy, while other antidegradants may cause a yellow to brown discoloration of the rubber surface, or staining of adjacent rubber surfaces to which they are in contact. Thus, the aesthetic appearance of the surface of the rubber is decreased.

### SUMMARY

In an embodiment, a tire sidewall rubber composition includes a natural or synthetic rubber polymer, and a polyester resin. The polyester resin includes a copolymer of maleic anhydride or maleic acid and a linear or branched polyol.

In an embodiment, a method for preparing a tire sidewall rubber composition includes mixing a natural or synthetic rubber polymer with a polyester resin. The polyester resin includes a copolymer of maleic anhydride or maleic acid and a linear or branched polyol.

In an embodiment, a tire includes a vulcanized sidewall component that includes a natural or synthetic rubber polymer and a polyester resin. The polyester resin includes a copolymer of maleic anhydride or maleic acid and a linear or branched polyol.

In an embodiment, a rubber composition includes a natural or synthetic rubber polymer; an antidegradant; and a polyester resin. The polyester resin includes a copolymer of maleic anhydride or maleic acid and a linear or branched polyol.

As used herein the terms “a” and “the” mean one or more, unless the context clearly indicates to the contrary.

### DETAILED DESCRIPTION

Unexpectedly, it was discovered that a polyester resin comprising a copolymer of maleic anhydride or maleic acid and a linear or branched polyol that is added to a rubber composition is beneficial to the aesthetic appearance of the rubber composition. The rubber composition is applied in a tire sidewall. This additive provides a black, glossy appearance to a tire sidewall even after being exposed to ozone, thereby improving its aesthetic appearance. Although not limited to this theory, the addition of the copolymer of maleic anhydride or maleic acid and a linear or branched polyol appears to mask the appearance of antidegradants on the outer surface of the rubber compound.

In an embodiment a rubber elastomer is used. For example, the elastomer may be selected from the following, individually as well as in combination, according to the desired final viscoelastic properties of the rubber compound: natural rubber, polyisoprene rubber, styrene butadiene rubber, polybutadiene rubber, poly(isoprene-styrene), poly(isoprene-butadiene), poly(isoprene-styrene-butadiene), butyl rubbers, halobutyl rubbers, ethylene propylene rubber, crosslinked polyethylene, neoprene, nitrile rubber, chlorinated polyethylene rubber, EPDM (ethylene propylene diene monomer rubber), silicone rubber, and thermoplastic rubbers, as such terms are employed in The Vanderbilt Rubber Handbook, Thirteenth Edition, (1990). In an embodiment, the composition is exclusive of ethylene-propylene-diene-terpolymer. These elastomers may contain a variety of functional groups, including but not limited to tin, silicon, and amine containing functional groups. The rubber polymers may be prepared by emulsion, solution, or bulk polymerization according to known suitable methods.

In an embodiment containing a blend of more than one polymer, the ratios (expressed in terms parts per hundred rubber (phr)) of such polymer blends can be adjusted according to the desired final viscoelastic properties desired for the polymerized rubber compound. For example, in an embodiment natural rubber or polyisoprene may comprise about 5 to about 80 phr, such as about 20 phr to about 60 phr, or about 35 phr to about 55 phr; and polybutadiene or styrene-butadiene rubber may comprise about 60 phr to about 5 phr, such as about 50 phr to about 10 phr, or about 15 phr to about 25 phr. In an embodiment, one of the rubbers above is selected and comprises the entire rubber component.

In an embodiment the rubber polymer, may have a number average molecular weight (Mn) of about 100,000 to about 1,000,000, such as about 150,000 to about 600,000, or about 250,000 to about 500,000. In an embodiment, the polydispersity of the rubber polymer (Mw/Mn) may range from about 1.5 to about 6.0, such as about 2.0 to about 5.0, or about 3.0 to about 4.0.

In an embodiment, an antidegradant is used to protect the rubber from the oxidation effects of atmospheric ozone. Many antidegradants are staining antidegradants, i.e., they cause a decrease in the visual appearance of the composition. As mentioned in the background, antidegradants may bloom to the surface and detract from the visual appearance of the rubber composition. The amount of total antidegradant or staining antidegradant in the composition may be, for example, from about 0.1 to about 15 phr, such as from about 0.3 to about 6 phr, or about 2 phr to about 7 phr. The antidegradant may be classified as an antozonant or antioxidant, such as those selected from: N,N′disubstituted-p-phenylenediamines, such as N-1,3-dimethylbutyl-N′phenyl-p-phenylenediamine (6PPD), N,N′-Bis(1,4-dimethylpently)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of antidegradants include, Acetone diphenylamine condensation product (Alchem BL), 2,4-Trimethyl-1,2-dihydroquinoline (Alchem TMQ), Octylated Diphenylamine (Alchem ODPA), and 2,6-di-t-butyl-4-methyl phenol (BHT).

In an embodiment, the reinforcing filler may be selected from the group consisting of carbon black, silica, and mixtures thereof. The total amount of reinforcing filler may be from about 1 to about 100 phr, from about 30 to about 80 phr, from about 40 to about 70 phr, or from about 50 to about 100 phr of filler.

The carbon black can be present in amounts ranging from about 0 to about 80 phr, such as about 5 to about 60 phr, or about 20 to about 50 phr. The carbon black may have a surface area (EMSA) of at least about 20 m²/g, such as, at least about 35 m²/g up to about 200 m²/g or higher. Surface area values used in this application are determined by ASTM D-1765 using the cetyltrimethyl-ammonium bromide (CTAB) technique.

Among the useful carbon blacks are furnace black, channel blacks and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks.

A mixture of two or more of the above blacks can be used in preparing the carbon black filled embodiments. The carbon blacks utilized in the preparation of the vulcanizable elastomeric compositions can be in pelletized form or an unpelletized flocculent mass.

A mixture of two or more of the above blacks can be used. Exemplary carbon blacks include, but are not limited to, N-110, N-220, N-339, N-330, N-352, N-550, and N-660, as designated by ASTM D-1765-82a.

Examples of reinforcing silica fillers which can be used include wet silica (hydrated silicic acid), dry silica (anhydrous silicic acid), calcium silicate, and the like. Among these, precipitated amorphous wet-process, hydrated silicas are preferred. Silica can be employed in an amount of about 1 to about 100 phr, or in an amount of about 5 to about 80 phr, or in an amount of about 30 to about 70 phr. The useful upper range is limited by the high viscosity imparted by fillers of this type. Some of the commercially available silicas that can be used include, but are not limited to, HiSil® 190, HiSil® 210, HiSil® 215, HiSil® 233, and HiSil® 243, produced by PPG Industries (Pittsburgh, Pa.). A number of useful commercial grades of different silicas are also available from DeGussa Corporation (e.g., VN2, VN3), Rhone Poulenc (e.g., Zeosil® 1165MP0), and J. M. Huber Corporation.

The surface area of the silicas may, for example, be about 32 m²/g to about 400 m²/g, such as about 100 m²/g to about 250 m²/g being preferred, or about 150 m²/g to about 220 m²/g. The pH of the silica filler is generally about 5.5 to about 7 or about 6 to about 7.2, or about 5.5 to about 6.8.

If silica is used as a filler, it may be desirable to use a coupling agent to couple the silica to the polymer. Numerous coupling agents are known, including but not limited to organosulfide polysulfides. Any organosilane polysulfide may be used. Suitable organosilane polysulfides include, but are not limited to, 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricycloneoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxyethoxypropoxysilyl 3′-diethoxybutoxy-silylpropyl tetrasulfide, 2,2′-bis(dimethylmethoxysilylethyl)disulfide, 2,2′-bis(dimethylsecbutoxysilylethyl) trisulfide, 3,3′-bis(methylbutylethoxysilylpropyl)tetrasulfide, 3,3′-bis(di t-butylmethoxysilylpropyl) tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethylmethoxysilylpropyl)tetrasulfide, 3,3′-bis(ethyldi-secbutoxysilylpropyl)disulfide, 3,3′-bis(propyldiethoxysilylpropyl) disulfide, 3,3′-bis(butyldimethoxysilylpropyl)trisulfide, 3,3′-bis(phenyldimethoxysilylpropyl)tetrasulfide, 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide, and 3-octanoylthio-1-propyltriethoxysilane (NXT). Mixtures of various organosilane polysulfide compounds can be used.

The amount of coupling agent in the composition is based on the weight of the silica in the composition. The amount of coupling agent present in the composition may be from about 0.1% to about 20% by weight of silica, or from about 1% to about 15% by weight of silica, or from about 2% to about 10% by weight of silica. For example, typical amounts of coupling agents include about 4, 6, 8, and 10 phr.

When both carbon black and silica are employed in combination as the reinforcing filler, they may be used in a carbon black-silica ratio of about 10:1 to about 1:4, such as about 5:1 to about 1:3, or about 2:1 to about 1:2.

Certain additional fillers may also be utilized, including mineral fillers, such as clay, talc, aluminum hydrate, aluminum silicate, magnesium silicate, aluminum hydroxide and mica. The foregoing additional fillers are optional and can be utilized in the amount of about 0.5 phr to about 40 phr.

In an embodiment, the composition comprises a surfactant. Examples of surfactants that may be added include, but are not limited to, polyoxyethylene sorbitan monostearate (e.g., Rheodol® Bs-106) and ether thioether surfactants, such as Vulkanol® 85 and Vulkanol® OT, both being produced by Bayer Corporation.

The amount of surfactant to be mixed into the vulcanizable rubber compound depends on the desired final appearance, as well as other environmental considerations such as expected ozone exposure. The amount of surfactant ranges, for example, from 0 to about 10 phr, such as about 0.5 to about 5 phr.

The copolymer of maleic anhydride or maleic acid and a linear or branched polyol may be, for example, a copolymer of maleic anhydride and polyethylene glycol (PEGM) such as poly(oxyethyleneoxybut-2-enedioyl), which includes repeat (“mer”) units of formula I

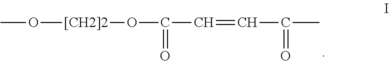

and carboxylic acid end groups.

In an embodiment, the copolymer may be in a resinous form as opposed to a fiber or particle form.

In an embodiment, a polyester resin (“unsaturated polyester”) that is a copolymer of maleic anhydride or maleic acid and a linear or branched polyol, may be prepared from an unsaturated dibasic acid and/or an anhydride; and a polyol (e.g., a diol) and/or an oxide. A saturated dibasic acid and/or an anhydride may be included as well in the reaction (e.g., a condensation reaction). Examples of an unsaturated dibasic acid and/or an anhydride include a maleic anhydride, an acrylic monomer (e.g., an acrylic acid, a methacrylic acid), an itaconic acid, a fumaric acid, or a combination thereof. Examples of a dibasic acid and/or an anhydride includes an adipic acid, a glutaric acid, a phthalic anhydride, an isophthalic acid, a cyclopentadiene-maleic anhydride, a tetrabromophthalic anhydride, a tetrachlorophthalic anhydride, a terephthalic acid, a chlorendic anhydride, a tetrahydrophthalic anhydride, or a combination thereof. Examples of a polyol and/or an oxide comprises a 1,4-butanediol; a 2,2,4-trimethylpentane-1,3-diol; a bisphenol dipropoxy ether; a dibromoneopentyl glycol; a dicyclopentadiene hydroxyl adduct; a diethylene glycol; a dipropylene glycol; an ethylene glycol; a neopentyl glycol; a propylene glycol; a propylene oxide; a tetrabromobisphenol dipropoxy ether, or a combination thereof.

In an embodiment, the polyester resin that is a copolymer of maleic anhydride or maleic acid and a linear or branched polyol may comprise an unsaturated monomer and/or polymer that may be involved in crosslinking, with examples including an acrylic (e.g., a methyl methacrylate), a styrene monomer (e.g., a styrene, an alpha methyl styrene, a chlorostyrene, tert-butyl styrene), a polystyrene, a divinyl benzene, a diallyl phthalate, a vinyl toluene, a triallyl cyanurate, or a combination thereof. Crosslinking generally occurs between the unsaturated double bond, and a free radical catalyst may be used to promote crosslinking.

The copolymer of maleic anhydride or maleic acid and a linear or branched polyol may be added to the rubber composition in an amount appropriate for a resulting desired visual and viscoelastic performance of the resulting compound, such as, for example, about 0.1 to about 10 phr, such as about 1 to about 6 phr, or about 4 to about 8 phr.

Additional rubber compounding ingredients may include curing packages, processing aids, coupling agents, and the like. For example, without limitation, the composition disclosed herein may also contain such additional ingredients in the following amounts:
processing oils/aids: from about 0 to about 75 phr, such as from about 5 to about 40 phr;
stearic acid: from about 0 to about 5 phr, such as from about 0.1 to about 3 phr;
zinc oxide: from about 0 to about 10 phr, such as from about 0.1 to about 5 phr;
sulfur: from about 0 to about 10 phr, such as from about 0.1 to about 4 phr; and
accelerators: from about 0 to about 10 phr, such as from about 0.1 to about 5 phr.

In an embodiment, the rubber composition including the copolymer of maleic anhydride or maleic acid and a linear or branched polyol exhibits an improvement in gloss. For example, the rubber composition may exhibit an improvement of about 1.1 to about 4 times, such as about 1.5 to about 3 times, or about 1.8 to about 2.3 times over a control composition that is the same but does not include the copolymer of maleic anhydride or maleic acid and a linear or branched polyol. The gloss improvement is measured by dE after 7 day static ozone testing, according to the method of the examples below.

After the final mixing stage, the filled polymeric composition may be molded and cured to form a rubber product. Example final products include tires, power belts, and vibration isolators. Tires include, for example, both pneumatic radial tires as well as pneumatic bias ply tires. In embodiments, the composition is a vulcanizable elastomeric composition that can be utilized to form sidewalls for such tires. Pneumatic tires can, for example, be made according to the constructions disclosed in U.S. Pat. Nos. 5,866,171; 5,876,527; 5,931,211; and 5,971,046, the disclosures of which are incorporated herein by reference. The composition can also be used to form other elastomeric tire components, such as treads, subtreads, body ply skims, or bead fillers.

Further embodiments are described in the following examples.

### EXAMPLES

### General Experimental Testing Procedures

1. Rheometer

A Rheometer is used to determine the cure characteristics of compounded rubbers. The procedure used to measure the cure of rubber samples follows ASTM D 2084. The sample size was 30 mm in diameter and 12.5 mm in thickness or equivalent to a volume of 8 cm3. The equipment used was a Monsanto Rheometer Model MDR2000.

2. Modulus, Tensile Strength and Elongation at Break

Modulus, Tensile Strength (Stress at Maximum Strain) and Elongation at Break are measured generally according to ASTM D 412 (1998) method B. Vulcanized rubber test specimens are cut into the shape of a ring, using a D412 B Type 1 die. The measurements for the above properties are based on the original cross sectional area of the test specimen. An instrument equipped to produce a uniform rate of grip separation, such as an Instron tensile tester, with a suitable dynamometer and an indicating or recording system for measuring applied force is used in conjunction with a measurement of extension of the test specimen. Modulus (100% (M100) and 300% (M300)), tensile strength (TB) and elongation (EB) are calculated according to the calculations set forth in ASTM D412 (1998).

3. Dynamic Ozone Testing (Bent Loop)

Bent loop surface ozone cracking helps to estimate a material's resistance to ozone. A 2.54 cm×2.54 cm×1.91 mm to 2.54 mm strip is cut with the grain from the material to be tested. This rubber strip is then cut into two samples that are 7.62 cm long. The samples are labeled and marked with a 4.44 cm bench mark and then, for the dynamic ozone testing, each sample is folded in the middle, and the ends are clamped together with a large binder clip. Next, the samples are attached to a rod, so they will be in an upright position during the test sequence.

The samples are placed into the ozone chamber for 1 and 3 days. The ozone chamber is kept at 50 parts of ozone to 100 million parts of air and at a temperature of 37.8° C.±1° C. The samples are checked daily for cracking. The time of the first signs of cracking is recorded. The samples are taken out of the chamber on the seventh day and visually inspected for the extent of cracking.

4. Color and Gloss

Color and Gloss are determined by the use of a Minolta CM2600D Spectrophotometer, calibrated according to the manufacturer's standards. For the static ozone testing, samples are exposed to 100 parts ozone per hundred million air at a temperature of 60° C.±1° C. for 7 days while statically strained. For this purpose, an ozone box, OREC model 0500/DM100 and ozone Monitor,® OREC model O3DM100 are used. At various points in time, spectrophotometer measurements are taken. These measurements, L, a, and b describe 3 axes, and identify a unique color. The vector difference between two colors, dE, can be calculated as follows:

dE=√((L₁−L₂)²+(a₁−a₂)²+(b₁−b₂)²)

Gloss is defined as the spectral reflectance produced by light hitting a surface, and can be expressed as the vectoral difference between the absolute color spectral component included of an object and the color reflected from its surface at a 10° angle.

### General Experimental Materials Examples

In these Examples, rubber compounds containing a PEGM (poly(oxyethyleneoxybut-2-enedioyl) polyester resin are compared to compounds without such PEGM polyester resin.

### Examples A-D

Example A was a control that was representative of rubber compositions for tire sidewalls without a PEGM polyester resin. Examples B, C, and D were compositions comprising 5 phr of PEGM.

Examples A, B, and C were mixed in two mix stages. Examples B and D included the EPDM, PEGM, and in Example D 8.5 phr of the HAF carbon black as part of a premasticated rubber. For the first non-productive mix stage, the ingredients were mixed for approximately 120 seconds to a temperature of about 155° C. The resulting rubber composition was then mixed with sulfur curatives, accelerators, antidegradants and in Examples B, C, and D, PEGM, to a maximum temperature of about 77° C., for about 145 seconds in a final, productive mix stage. Example D included a first and second masterbatch stage with a final stage, wherein the second masterbatch stage had the same mixing conditions as the first masterbatch stage.

Table 1 contains the formulations for each of the Examples A-D.

TABLE 1

| Materials | Ex. A | Ex. B | Ex. C | Ex. D |
|---|---|---|---|---|
| Masterbatch #1 | | | | |
| Nickel catalyzed 96% cis polybutadiene | 50 | 50 | 50 | 55 |
| (−108 Tg) Natural Rubber | 30 | 30 | 30 | 27.5 |
| EPDM KELTAN 55 - 8% ENB, 52% | 20 | 20 | 20 | 17.5 |
| Ethylene, 56/44 E/P Ratio | | | | |
| Carbon Black | 45 | 45 | 45 | 0 |
| HAF Carbon Black | 0 | 0 | 0 | 45 |
| Silica | 10 | 8 | 8 | 8 |
| Processing Oil | 5 | 5 | 5 | 5 |
| Liquid S2 Silane | 1.2 | 1.2 | 1.2 | 1.2 |
| (bis(triethoxysilylpropyl)disulfide) | | | | |
| Zinc Oxide | 2.5 | 2.5 | 2.5 | 2.5 |
| Phenolic Resin | 3 | 3 | 3 | 3 |
| PEGM | 0 | 5 | 5 | 5 |
| Stearic Acid | 1.5 | 2 | 2 | 2 |
| 6PPD Antidegradant¹ | 4 | 4 | 4 | 0.5 |
| TMQ | 2 | 2 | 2 | 0 |
| Aliphatic Hydrocarbon Resin | 6 | 6 | 6 | 0 |
| Hydrocarbon Resin(aliphatic, naphthenic, | 0 | 0 | 0 | 6 |
| aromatic) | | | | |
| Masterbatch #2 | | | | |
| Antidegradant (hindered phenol AO) | N/A | N/A | N/A | 2 |
| 6PPD¹ | N/A | N/A | N/A | 2.5 |
| Final | | | | |
| Sulfur | 1.4 | 1.4 | 1.4 | 1.4 |
| DPG—Diphenylguanidine | 0.3 | 0.45 | 0.45 | 0.45 |
| TBBS² | 0.6 | 0.6 | 0.6 | 0.6 |

¹6PPD is an antioxidant and is available as Santoflex 13 from Flexsys
²Santocure TBBS, available from Flexsys.

Samples of each of these compounds were then vulcanized at a temperature of about 150° C. for about 15 minutes. The physical properties for the resulting vulcanized rubber are shown in Table 2.

TABLE 2

| | Ex. A | Ex. B | Ex. C | Ex. D |
|---|---|---|---|---|
| Rheometer | | | | |
| ML, in-lb | 1.69 | 1.51 | 1.56 | 1.46 |
| MH, in-lb | 8.24 | 8.32 | 8.22 | 9.00 |
| ts2 | 3.50 | 2.87 | 2.91 | 4.06 |
| t-10, min | 2.71 | 2.11 | 2.14 | 3.26 |
| t-50, min | 4.11 | 3.65 | 3.67 | 5.05 |
| t-90, min | 7.55 | 7.16 | 7.26 | 9.09 |
| Stress/Strain | | | | |
| M300 @ RT | 8.80 | 8.37 | 8.39 | 7.53 |
| TB @ RT | 11.65 | 11.10 | 11.19 | 12.13 |
| EB @ RT | 428 | 434 | 436 | 529 |
| Ozone Testing- | No | No | No | No |
| Bent Loop | Break | Break | Break | Break |
| Days to Break | | | | |

As can be seen by the data contained in Table 2, the physical properties of the sidewall compound are not significantly affected by the addition of PEGM.

Color and Gloss Results

Color and gloss data was obtained according to the test procedures described above. The results of the dynamic ozone testing are included in Table 3. The results of the static ozone testing are included in Table 4.

TABLE 3

| | Ex. A | Ex. B | Ex. C |
|---|---|---|---|
| Color and Gloss | | | |
| 1 day Ozone Exposure | | | |
| L | 20.47 | 16.91 | 18.59 |
| a | 0.41 | −0.1 | −0.07 |
| b | 5.49 | 1.71 | 2.69 |
| Color and Gloss | | | |
| 3 days Ozone Exposure | | | |
| L | 17.88 | 21.72 | 23.32 |
| a | 1.35 | 0.93 | 0.33 |
| b | 3.5 | 2.8 | 1.59 |

TABLE 4

| | Ex. A | Ex. B | Ex. C |
|---|---|---|---|
| Color and Gloss | | | |
| 7 days Ozone Exposure | | | |
| SCI L | 27.24 | 27.12 | 25.92 |
| SCI a | −0.03 | 0.05 | 0.05 |
| SCI b | −0.62 | 0.01 | −0.59 |
| SCE L | 24.94 | 21.44 | 20.2 |
| SCE a | −0.12 | 0.12 | 0.03 |
| SCE b | −0.89 | 0.27 | −0.04 |
| dE (gloss) | 2.32 | 5.69 | 5.75 |

As can be seen by the data in Table 3, the staining (b) for Examples B and C that both contain PEGM, is less than the staining in control Example A that does not contain PEGM. As can be seen by the data in Table 4, the gloss value (dE) in Examples B and C, which both contain PEGM, is considerably higher than the gloss value in control Example A that does not contain PEGM. The data demonstrates that PEGM increases the gloss on the surface of rubber samples and prevents surface discoloration.

The invention is not limited to only the above embodiments. The claims follow.

What is claimed is:

1-15. (canceled)

16. A tire sidewall rubber composition comprising
a natural or synthetic rubber polymer; and
a polyester resin comprising a copolymer of maleic anhydride or maleic acid and a linear or branched polyol.

17. The tire sidewall rubber composition of claim 16, wherein the copolymer of maleic anhydride or maleic acid and a linear or branched polyol is a copolymer of maleic anhydride and polyethylene glycol.

18. The tire sidewall rubber composition of claim 16, wherein the polyester resin is present in an amount of from about 0.1 phr to about 10 phr.

19. The tire sidewall rubber composition of claim 16, further comprising an antidegradant.

20. The tire sidewall rubber composition of claim 16, further comprising a reinforcing filler.

21. The tire sidewall rubber composition of claim 16, wherein the at least one rubber polymer is selected from the group consisting of natural rubber, polyisoprene rubber, styrene butadiene rubber, polybutadiene rubber, poly(isoprene-styrene), poly(isoprene-butadiene), poly(isoprene-styrene-butadiene), butyl rubbers, halobutyl rubbers, ethylene propylene rubber, crosslinked polyethylene, neoprene, nitrile rubber, chlorinated polyethylene rubber, EPDM, and silicone rubber.

22. The tire sidewall rubber composition of claim 16, wherein the composition is exclusive of ethylene-propylene-diene-terpolymer.

23. The tire sidewall rubber composition of claim 19, wherein the antidegradant is a staining antidegradant selected from N,N′disubstituted-p-phenylenediamines.

24. A method for preparing a tire sidewall rubber composition comprising mixing
a natural or synthetic rubber polymer; with
a polyester resin comprising a copolymer of maleic anhydride or maleic acid and a linear or branched polyol.

25. The method of claim 24, wherein the copolymer of maleic anhydride or maleic acid and a linear or branched polyol is a copolymer of maleic anhydride and polyethylene glycol.

26. The method of claim 24, wherein the polyester resin is present in an amount of from 0.1 phr to 10 phr.

27. The method of claim 24, further comprising mixing an antidegradant.

28. The method of claim 27, wherein the antidegradant is a staining antidgradant selected from N,N′disubstituted-p-phenylenediamines.

29. The method of claim 24, further comprising mixing a reinforcing filler.

30. A tire comprising a vulcanized sidewall component comprising
a natural or synthetic rubber polymer; and
a polyester resin comprising a copolymer of maleic anhydride or maleic acid and a linear or branched polyol.

31. The tire of claim 30, wherein the copolymer of maleic anhydride or maleic acid and a linear or branched polyol is a copolymer of maleic anhydride and polyethylene glycol.

32. The tire of claim 30, further comprising a reinforcing filler.

33. The tire of claim 30, further comprising an antidegradant.

34. A rubber composition comprising:
a natural or synthetic rubber polymer;
an antidegradant; and
a polyester resin comprising a copolymer of maleic anhydride or maleic acid and a linear or branched polyol.

35. The rubber composition of claim 34 wherein the antidegradant is an antidegradant that blooms to the surface of the rubber composition.
